(19) United States
(12) Patent Application Publication
(10) Pub. No.: US 2008/0041359 A1
(43) Pub. Date: Feb. 21, 2008

(54) OVEN COOKER FOR BARBECUE

(76) Inventor: Jae Kyoung Kim, Hwa Sung (KR)

Correspondence Address: ORION LAW GROUP, 3 HUTTON CENTRE, SUITE 850, SANTA ANA, CA, 92707, US

(21) Appl. No.: 11/744,791

(22) Filed: May 4, 2007

(30) Foreign Application Priority Data
Aug. 17, 2006 (KR) 2006-0077790

(51) Int. Cl. A47J 37/07

(52) U.S. Cl. 126/25 R

(57) ABSTRACT

Disclosed is an oven cooker for barbecue to resolve problems of difficult manipulation in charcoal supply or exchange of a charcoal case, which causes fire and burns. The oven cooker for barbecue of the present invention includes a main body mounted with hangers for cooking stuff inside an inlet and formed with an opening at a lower part, and a charcoal base mounted with a charcoal case in a lower part thereof and detachably mounted to the opening of the main body at an upper end, wherein a movable frame mounted with the charcoal base via a supporting ring at an upper part is movable by mounting a plurality of casters at a lower part, and mounted with a cam shaft at the lower part and mounted with cams by a handle to control lifting of the charcoal case, and wherein the charcoal base is mounted with the charcoal case having ventilation holes and a tray provided with a barrier wall covers the ventilation holes of the charcoal case with a distance the ventilation holes, so that oil of foodstuff is prevented from being introduced into the charcoal case via the ventilation holes. Therefore, any unskilled persons such as women or old people may detach or attach the charcoal base to or from the main body without suffering such as fire or burns, and cooking stuff may be supplied with high quality without black dirt caused by the dropping oil.

### BACKGROUND OF THE INVENTION

1. Field of the Invention

The present invention relates to an oven cooker, and more particularly to, an oven cooker for barbecue for meat such as chickens or ducks to cook with charcoal fire in which a charcoal base mounted at a lower part of a main body may be moved by casters to be easily attached to or detached from the main body, so that the danger in the movement or exchange of charcoal fire may be reduced.

According to the present invention, the attachment or detachment of the charcoal base to or from the main body may be carried out easily and conveniently, so that any one who is not skilled in the barbecue may use the oven cooker for barbecue easily.

2. Discussion of Related Art

In general, when cooking meat such as chickens, ducks and pork by barbecue, the meat may be cooked by a direct heating cooker via direct contact with a heat source such as charcoal fire or by an oven using heat from the charcoal fire without any direct contact with the charcoal fire.

As the heat source for meat barbecue, wood fire may be used instead of the charcoal fire, but only charcoal fire will be described in the present invention for the sake of convenience of explanation.

Usually, the barbecue using the direct heating cooker is preferable for the meat such as chickens, ducks and port having lots of oil to improve their natural smell by impregnating the meat with the charcoal smell if the meat is properly cooked by the direct charcoal fire contact. The direct heating type barbecue has, however, a disadvantage that the oil seeping from the meat during the cooking drops down to the charcoal fire, generating smoke. Therefore, restaurants specialized in the barbecue should invest lost of money for facilities such as forcible exhaust duct systems mounted to each table to handle the smoke.

Further, the direct heating type barbecue has another disadvantage that black dirt and scorching are generated on the surface of the meat even by a slight carelessness, which deteriorate the taste of the meat and induce cancer. Therefore, people hesitate to choose the direct heating type barbecue in spite of the attractive taste of the barbecue meat and lots of restaurants select the oven type indirect heating for barbecue, which generates less smoke.

The present applicant has suggested an oven type indirect barbecue cooker using heat of charcoal fire as disclosed in Korean Utility Model Reg. No. 207270.

According to this prior art, the oil seeping from the meat during cooking is prevented from dropping down to the charcoal fire directly so that little smoke is generated. Further, the meat is cooked by the heat of the charcoal fire indirectly so that the surface of the meat becomes tempting brown without scorching or black dirt. Therefore, the barbecue cooker is currently widely utilized in various restaurants with high popularity.

The barbecue cooker of the present applicant has, however, a disadvantage in the supply of charcoal fire. In the prior art barbecue cooker, a charcoal base supporting a charcoal case is suspended to a bottom surface of a main body at a predetermined height from the ground surface and attached to detached from the main body by holding pieces and locking pieces. Therefore, in order to supply the charcoal fire into the charcoal case, the charcoal base has to be separated from a lower part of the main body and laid down on the ground. Then, the charcoal fire put in an additional container should be moved into the charcoal case in the charcoal base.

In the above structure, the charcoal fire may be dropped down even by a slight carelessness during the movement of the charcoal base or the additional case receiving the charcoal fire. Further, users may be burnt by sparks of the charcoal fire while moving the charcoal fire from the container to the charcoal case.

Furthermore, even though the dangerous supply of the charcoal fire is finished safely, the charcoal base should be lifted to be attached to the lower part of the main body, the holding pieces and the locking pieces should be engaged with each other, and the charcoal base should be rotated in a direction by using both hands to keep coupling states between the charcoal base and the main body, wherein all the above handling is still complicated and troublesome work, so that it is very hard to be carried out by women or old people and even strong men should carry out the above process very carefully.

In addition, in order to add the charcoal fire further when the charcoal fire becomes weaken in the process of cooking, the charcoal base should be held by both hands and rotated in the opposite direction to be separated from the main body. And the separated charcoal base should be attached to the main body again by carrying out the above complicated and dangerous procedure after the adding of the charcoal fire is finished. Therefore, the danger of burns follows always and the workability is also decreased.

In the meantime, ventilation holes of the charcoal case, which is mounted in the lower part of the charcoal base, are exposed to the outside, so that the oil seeping from the meat and falling down along an inner peripheral wall of the charcoal base may be dropped down near the ventilation holes of the charcoal case. In this case, the charcoal fire may be moved to the oil and the charcoal case itself may be enveloped in the charcoal fire entirely. Seriously, the charcoal fire may be moved to the oil dropped down on the bottom of the charcoal base and control of the fire in a cooking chamber becomes difficult. Conclusionally, the meat becomes dark by the moved charcoal fire and smoke may be generated therefrom, which result in the deterioration of the taste of the meat.

### SUMMARY OF THE INVENTION

Therefore, the present invention is derived to resolve the above and any other disadvantages of the prior art.

According to the present invention, there is an object to provide an oven cooker for barbecue, in which a charcoal base may be simply attached to or detached from a main body even by unskilled persons such as women or old people for supplying charcoal fire or exchange the charcoal case with a new one safely.

Another object of the present invention is to provide an oven cooker for barbecue, in which oil dropped from foodstuff such as meat is prevented from being introduced into ventilation holes of a charcoal case to avoid spreading out of the charcoal fire in the charcoal case through all the ventilation holes or moved to oil dropped down on the bottom of the charcoal base.

### BRIEF DESCRIPTION OF THE DRAWINGS

The objects, features and advantages of the present invention will be more clearly understood from the following detailed description in conjunction with the accompanying drawings, in which:

FIG. 1 is a perspective view showing a main body and a charcoal base of an oven cooker for barbecue according to a preferred embodiment of the present invention, wherein the main body and the charcoal base are disassembled from each other;

FIG. 2 is a perspective view of a bottom surface of the main body of the oven cooker for barbecue according to the present invention;

FIG. 3a is a cross-sectional view showing the main body secured on a movable frame and the charcoal base of the oven cooker for barbecue, which are separated from each other;

FIG. 3a is a cross-sectional view showing the main body secured on a movable frame and the charcoal base of the oven cooker for barbecue, which are coupled with each other; and

FIG. 4 is a partially expanded view showing the charcoal base lifted by cams.

### DETAILED DESCRIPTION OF THE PREFERRED EMBODIMENTS

Now preferred structure and operations of an oven cooker for barbecue to achieve the above objects will be described in the preferred embodiments according to the present invention with reference to the accompanying drawings.

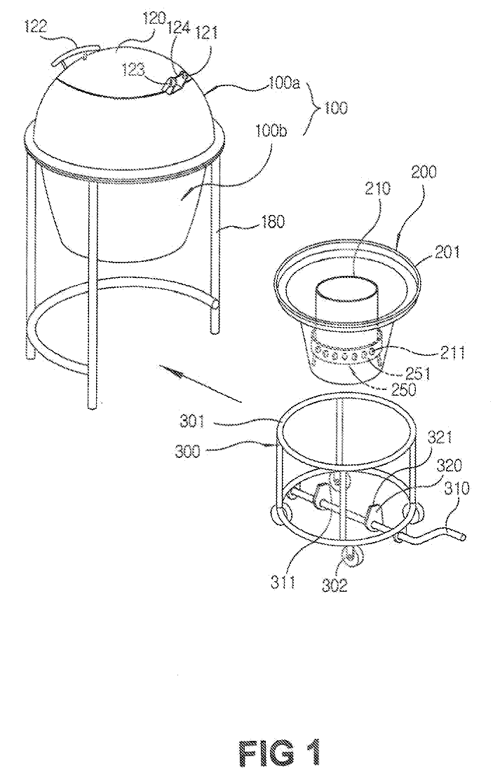

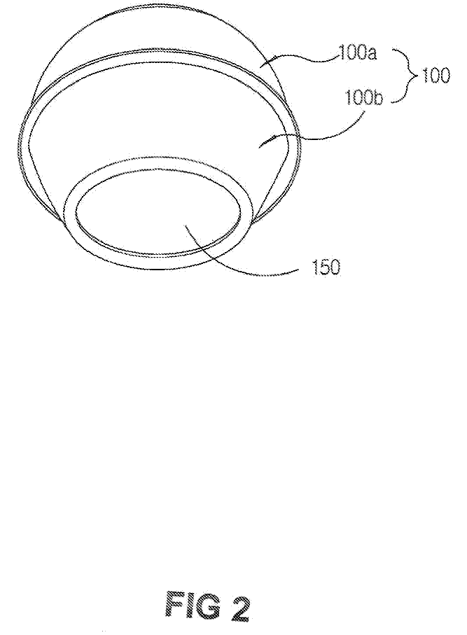

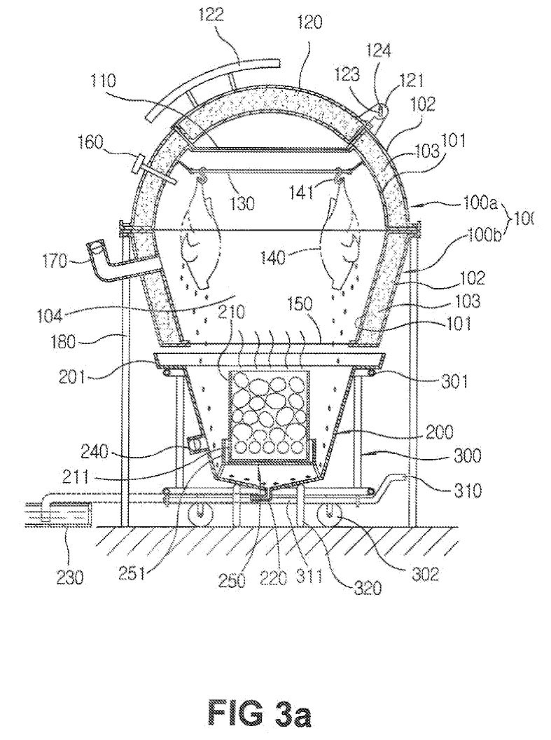

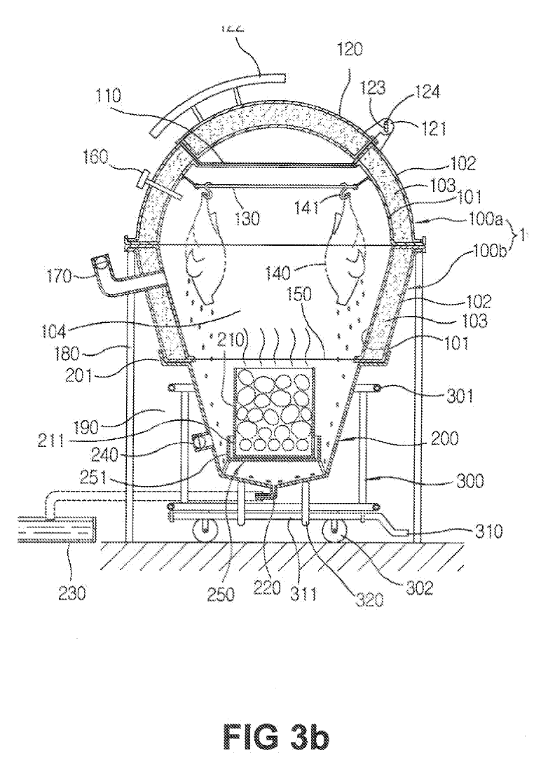

FIG. 1 is a perspective view showing a main body and a charcoal base of an oven cooker for barbecue according to a preferred embodiment of the present invention, wherein the main body and the charcoal base are disassembled from each other, FIG. 2 is a perspective view of a bottom surface of the main body of the oven cooker for barbecue according to the present invention, and FIG. 3a and FIG. 3b are cross-sectional views respectively showing disassembled and assembled states of the main body secured on a movable frame and the charcoal base of the oven cooker for barbecue.

Referring to FIG. 1 to FIG. 3, a main body 100 provided with a cooking chamber 104 is formed with an upper body 100a and a lower body 100b, which are prepared separately and then assembled together into the single main body for the sake of manufacturing, but may be formed in the single body from the beginning as necessary. The upper and lower bodies are respectively formed of an inner wall 101 and an outer wall 102 and insulating warmth-keeping substances 103 are filled in a gap between the inner wall 101 and the outer wall 102.

The main body 100 is formed with an inlet 110 at an upper part to be opened or closed by a lid 120. The lid 120 is formed with an elongated axial hole 123 at a hinge part 121, so that the lid 120 is entirely movable in the up and down direction with respect to a hinge shaft 124. Therefore, when the lid 120 is closed, the lid 120 which is suspended by the hinge part 121 may closely contact the inlet 110 of the main body 100 not only at a front end thereof but also at a rear end thereof, thereby increasing sealing force for the cooling chamber 104.

A plurality of hangers 130 are mounted to an inner wall surface 101 of the main body 100 in the inlet 110, wherein the hangers 130 are formed with hooks 141 to hang foodstuff such as meat.

A charcoal base 200 is a separate element from the main body 100, so that an upper end part 201 of the charcoal base 200 is detachably attached to the opening 150 at the lower end of the main body 100.

A tray 250 is mounted at a lower part in the charcoal base 200, and mounted with a charcoal case 210 therein, wherein the tray is apart from a bottom surface of the charcoal base 200 by a predetermined distance so that oil dropping down along an inner peripheral wall of the charcoal base may advance to an oil outlet 220. The tray 250 is mounted with a barrier wall 251 at a rim part thereof, wherein the barrier wall 251 is mounted with a predetermined distance from ventilation holes 11 and has a height enough to cover the ventilation holes 211 of the charcoal case 210, so that oil dropping down from the meat is prevented from being introduced into the charcoal case via the ventilation holes 211.

A movable frame 300 has a supporting ring 301 at an upper part to be fitted with the charcoal base 200 and is movable by a plurality of casters 301, which are mounted at a lower part thereof. The movable frame 300 secures the charcoal base 200 at is upper part, so that the charcoal base 200 is attached to or detached from the opening 150 of the main body 100 as being secured on the movable frame 300.

The movable frame 300 is mounted with a cam shaft 311 at the lower part, which is apart from the ground surface by a predetermined distance by the casters 302, wherein the cam shaft 311 is rotated by a handle 310. The cam shaft 311 is mounted with a pair of cams 320 for controlling lifting of the charcoal base 200 by contact between the bottom surface of the charcoal base 200 and front ends 321 of the cams 320. The upper end 201 of the charcoal base 200 is attached to or detached from the lower opening 150 of the main body 100 by the positions of the cams 320.

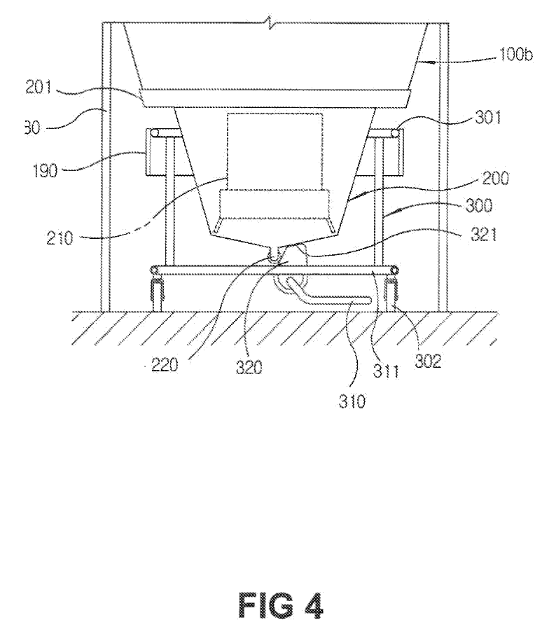

FIG. 4 is a partially expanded view showing the charcoal base 200 lifted by cams 320. In FIG. 4, the front ends 321 of the cams 320, serving as the contact parts, are preferably formed with surfaces having a predetermined inclination so as to increase contact areas for the charcoal base 200 and serve as stoppers.

Unexplained symbol 122 represents a handle of the lid 120, 160 represents a thermometer for measuring an internal temperature of the cooking chamber 104, 170 represents a heat emission part mounted to the main body 100, 180 represents supporting legs for supporting the main body, 220 represents the oil outlet formed in the center of the bottom of the charcoal base 200, 230 represents an oil receiver, and 240 represents an air inlet mounted with a well-known air controller(not shown).

According to the present invention as described hereinabove, foodstuff such as meat 140 may be suspended by each of the hooks 141 per the hanger 130, which are mounted to the inner peripheral surface of the main body, or withdrawn via the inlet 110 after cooking by opening the lid 120, which is opened or closed by the hinge part.

If the lid 120 is closed for cooking, the entire lid 120 closely contacts the inlet 110 by the elongated axial hole 123 of the hinge 121, so that the cooking chamber 104 is sealed tightly and the internal temperature of the cooking chamber 104 is raised shortly.

As the internal temperature of the main body 100 is raised by heat of charcoal fire in the charcoal case 210, which is secured in a lower part of the charcoal base 200, the foodstuff 140 hanging by the hangers 130 is cooked gradually. The foodstuff 140 is positioned on the central line of the main body 100 since the hangers 130 are mounted to the inner peripheral surface of the main body 100, so that the foodstuff 140 is cooked indirectly without direct contact with the charcoal fire.

Oil, which seeps from the foodstuff 140 by the heat of the charcoal fire of high temperature, is dropped down only at edge portions beyond the charcoal case 210, so that the oil is collected in the oil receiver via an additional hose, which is connected to the oil outlet, and not drops down to the charcoal fire in the charcoal case 210, which is positioned in the center of the charcoal base 200. Therefore, no smoke is generated during the barbecue.

The charcoal case 210 is positioned with a predetermined distance from the bottom of the charcoal base 200 and the ventilation holes 211 of the charcoal case 210 are covered by the barrier wall 251 of the tray 250, so that the hot oil dropped down from the foodstuff 140 toward the inner peripheral wall of the charcoal base 200 is not sputtered to the ventilation holes 211 of the charcoal case 210.

Therefore, the charcoal fire is not moved to the ventilation holes 211 of the charcoal case 210 or the oil at the bottom of the charcoal base 200, so that the foodstuff becomes safe from the black dirt generated by the movement of the charcoal fire, and the charcoal fire for the cooking chamber may be kept with uniform intensity. Therefore, the foodstuff may be cooked evenly in good states.

The internal temperature of the cooking chamber 104 is controlled by only the heat emission part 170, which is controlled to be opened or closed, while the inlet 110 formed at the upper part of the main body 100 is closed by the lid 120. Therefore, the cooking chamber 104 is sealed and moisture discharged from the foodstuff 140 is not discharged to the outside but stays in the cooking chamber 104, so that any additional moisture controlling water case is not required.

In order to supply charcoal fire into the charcoal case 210 while the charcoal base 200 is attached to the main body in close contact with the lower opening 150 of the main body 100, the handle 310 of the cam shaft 311, which is mounted to the movable frame 300, is rotated in a direction so that the front ends 321 of the cams 320 facing upward are lowered as shown in FIG. 3b. Then, the charcoal base 200 supported by the front ends 321 of the cams 320 becomes lowered by a predetermined height in the movable frame 300.

Therefore, the upper end 201 of the charcoal base 200 is separated from the lower opening 150 of the main body 100 and the charcoal base 200 secured on the movable frame 300 may be moved anywhere by the movable frame 300.

Therefore, the charcoal base 200 may be moved to a proper place for supplying charcoal fire by the movable frame 300, and users may put charcoal fire into the charcoal case 210, which is secured to the charcoal base 200, easily without suffering. After the charcoal fire supply, the charcoal base 200 may be moved to below the main body 100 stably by the movable frame 300. Therefore, the safety in the use may be improved.

After the charcoal base 200 is moved to the immediately below of the lower opening 150 of the main body 100 by moving the movable frame 300 and the handle 310 of the cam shaft 311 mounted to the movable frame 300 is rotated in the opposite direction from the beginning as shown in FIG. 3b, the front ends 321 of the cams 320 push the bottom surface of the charcoal base 200 and the front end 201 of the charcoal base 200 comes into close contact with the lower opening 150 of the main body 100 at its upper end 201 again.

At this time, the front ends 321 of the cams 320 are the slant surfaces having the predetermined inclination, and support the bottom surface of the charcoal base 200 in close contact stably, so that the attachment state of the charcoal base 200 is kept stably during the whole barbecue cooking.

As described hereinabove, according to the present invention, the charcoal base may be attached to or detached from the lower opening of the main body without suffering while the charcoal base is secured on the movable frame, so that the charcoal fire may be supplied or exchanged in a short time without the danger of fire or burns.

Further, the hot oil seeping from the foodstuff such as meat is prevented from sputtering to the ventilation holes of the charcoal case, which is positioned at a lower part of the foodstuff, so that the charcoal fire is prevented from moving to the charcoal case or the bottom of the charcoal base. Furthermore, the foodstuff may be cooked clean and uniformly without any dirt, thereby improving cooking quality. Also, the oven cooker for barbecue of the present invention may be manipulated easily and conveniently by unskilled people such as women or old people.

Although the foregoing description has been made with reference to the preferred embodiments, it is to be understood that changes and modifications of the present invention may be made by the ordinary skilled in the art without departing from the spirit and scope of the present invention and appended claims.

What is claimed is:

1. An oven cooker for barbecue comprising a main body formed with an inlet at an upper part of a cooking chamber to be opened and closed by a lid and an opening at a bottom part, and mounted with hangers having hooks for holding foodstuff to an inner wall of the cooking chamber, and a charcoal base securing a charcoal case of a predetermined size at a lower part surface inside and having an upper part to be detachably mounted to the lower opening of the main body, characterized in that a movable frame is mounted with a supporting ring at an upper end for inserting the charcoal base and a plurality of casters at a bottom surface so that the movable frame moves while securing the charcoal base thereon, wherein the movable frame has a cam shaft mounted with a pair of cams contacting a bottom surface of the charcoal case and rotating by a handle, so that the charcoal base is detachably mounted to the opening of the main body according to positions of the cams.

2. The oven cooker for barbecue as claimed in claim 1, wherein the cams mounted to the movable frame have front ends serving as contact parts, and the front ends are formed with surfaces of a predetermined inclination to keep the charcoal base lifted.

3. The oven cooker for barbecue as claimed in claim 1, wherein a tray is mounted on an inner bottom of the charcoal base with a predetermined height and a charcoal case is secured in the tray, and a barrier wall is mounted at a rim part of the tray with a distance from ventilation holes of the charcoal case for covering the ventilation holes so that oil dropped from foodstuff is prevented from being introduced into the charcoal case via the ventilation hole.

4. The oven cooker for barbecue as claimed in claim 2, wherein a tray is mounted on an inner bottom of the charcoal base with a predetermined height and a charcoal case is secured in the tray, and a barrier wall is mounted at a rim part of the tray with a distance from ventilation holes of the charcoal case for covering the ventilation holes so that oil dropped from foodstuff is prevented from being introduced into the charcoal case via the ventilation hole.
